(19) United States
(12) Patent Application Publication
(10) Pub. No.: US 2009/0220255 A1
(43) Pub. Date: Sep. 3, 2009

(54) MAINTENANCE UNIT AND MAINTENANCE METHOD OF IMAGE FORMING APPARATUS

(75) Inventors: Yukio Futamata, Shimizu-cyou (JP); Taizou Nozawa, Yokohama-shi (JP); Shin Yamauchi, Yokohama-shi (JP); Kazuhisa Takeda, Shizuoka-ken (JP); Tetsuya Nakamura, Koutou-ku (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/394,382

(22) Filed: Feb. 27, 2009

Related U.S. Application Data
(60) Provisional application No. 61/032,362, filed on Feb. 28, 2008.

(51) Int. Cl. G03G 15/00

(52) U.S. Cl. 399/31

(57) ABSTRACT

It is possible to provide a technique capable of grasping the necessity of the maintenance for a plurality of maintenance-oriented components in managing a maintenance work in an image forming apparatus containing the plurality of maintenance-oriented components.

A maintenance method of an image forming apparatus includes: obtaining information for a use state of each of a plurality of maintenance-oriented components; obtaining maintenance information for a state of needing maintenance, the state being preset for each of the plurality of maintenance-oriented components; determining whether or not the plurality of maintenance-oriented components lie in a state of needing maintenance, based on the obtained information for a use state and the obtained maintenance information; and reporting in order to take a look at a maintenance-oriented component which is determined to need maintenance.

### CROSS-REFERENCE TO RELATED APPLICATION

This application is based upon and claims the benefit of priority from: U.S. provisional application 61/032,362, filed on Feb. 28, 2008, the entire contents of each of which are incorporated herein by reference.

### TECHNICAL FIELD

The present invention relates to a technique for maintaining components which need maintenance and contained in an image forming apparatus.

### BACKGROUND

An image forming apparatus such as an electrophotographic apparatus is equipped with components which are expended or consumed accompanied by use of the apparatus. These components need maintenance such as a component change or a calibration of installment state of the components etc., according to use contents of the image forming apparatus. Hereinafter, the components which need such maintenance are referred to as “maintenance-oriented components.”

In a maintenance of a conventional image forming apparatus, when copies of the image forming apparatus are counted and it reaches preset copies, a message indicative of needing maintenance for maintenance-oriented components contained therein is displayed with an image. In addition, the image forming apparatus is provided with a counter for counting copies, and the maintenance is often made by a service man checking a count value of the counter.

However, in order to keep a stability of image quality in a recent image forming apparatus (specifically, in a color apparatus), a test print is periodically performed for a photoconductive member or a transcript belt and then the output result is checked, to optimize a variety of image forming conditions (so-called “image quality keeping control”).

As such, the image stability operation is organized in addition to an operation for forming images on a recording medium in a recent image forming apparatus. Thus, a substantial lifetime of a variety of maintenance-oriented components including the photoconductive member and the like is not simply determined by copies.

Especially, a use state of a user (print frequency, copies per one time, a color and black-and-white ratio) causes many frequencies of the above-described image stability operation and thus the maintenance-oriented components sometimes reach the lifetime at the preset copies or less.

In addition, different units are used for a black-and-white print and a color print, so it is difficult to simply determine lifetimes of the maintenance-oriented components by copies only in the recent image forming apparatus.

In order to solve the problems, it is disclosed that a plurality of main units are displayed as periodic maintenance-need units, as well as a list containing copies, reference copies, a driving time, a reference driving time, a previous change date and a next change date of the main units can be displayed, and that, when the driving time exceeds the reference driving time, a mark is displayed (Japanese Patent Application Laid-Open No. 2003-324570).

In the prior art, however, a service man cannot actually read the display until he switches the image forming apparatus into a maintenance mode. Thus, the maintenance work is a burden in that a service man himself visits periodically and conducts a maintenance mode to grasp a driving situation of a main body of the image forming apparatus or a periodic maintenance time.

### SUMMARY

An object of the present invention is to provide a technique capable of grasping whether or not to need maintenance for a plurality of maintenance-oriented components in managing a maintenance work in an image forming apparatus containing the plurality of maintenance-oriented components.

In order to accomplish the object, an aspect of the present invention relates to a maintenance unit of an image forming apparatus including: a use information obtaining section configured to obtain information for a use state of each of a plurality of maintenance-oriented components; a maintenance information obtaining section configured to obtain maintenance information for a state of needing maintenance, the state being preset for each of the plurality of maintenance-oriented components; a maintenance determining section configured to determine whether or not the plurality of maintenance-oriented components lie in a state of needing maintenance, based on the information obtained by the use information obtaining section and the maintenance information obtaining section; and a report control section configured to report in order to take a look at a maintenance-oriented component which is determined to need maintenance by the maintenance determining section.

Another aspect of the present invention relates to a maintenance unit of an image forming apparatus including: a use information obtaining section configured to obtain information for a use state of each of a plurality of maintenance-oriented components; a maintenance information obtaining section configured to obtain maintenance information for a state of needing maintenance, the state being preset for each of the plurality of maintenance-oriented components; a state estimating section configured to estimate a future use state of a maintenance-oriented component corresponding to information, based on the information for a use state obtained in the past by the use information obtaining section; a maintenance determining section configured to determine whether or not a use state estimated within a predetermined time period lies in a state of needing maintenance for each of the plurality of maintenance-oriented components, based on a use state estimated by the state estimating section and information obtained by the maintenance information obtaining section; and a report control section configured to report in order to take a look at a maintenance-oriented component which is determined to need maintenance by the maintenance determining section.

An aspect of the present invention relates to a maintenance method of an image forming apparatus including: obtaining information for a use state of each of a plurality of maintenance-oriented components; obtaining maintenance information for a state of needing maintenance, the state being preset for each of the plurality of maintenance-oriented components; determining whether or not the plurality of maintenance-oriented components lie in a state of needing maintenance, based on the obtained information for a use state and the obtained maintenance information; and reporting in order to take a look at a maintenance-oriented component which is determined to need maintenance.

### DESCRIPTION OF THE DRAWINGS

FIG. 1 is an external perspective view of an image forming apparatus having “maintenance unit of image forming apparatus” according to a first embodiment of the present invention;

FIG. 2 is a longitudinal cross-sectional view to illustrate the maintenance unit of the image forming apparatus according to the first embodiment of the present invention;

FIG. 3 is a longitudinal cross-sectional view to illustrate a process unit of the image forming apparatus according to the first embodiment of the present invention;

FIG. 4 is a longitudinal cross-sectional view to illustrate a detail of a configuration of a fixer for fixing a toner image, which is transcribed into a sheet from a middle transcript belt, to the sheet by heating;

FIG. 5 is a view to illustrate a basic configuration of a control circuit of the maintenance unit of the image forming apparatus according to the first embodiment of the present invention;

FIG. 6 is a view to illustrate details of a display unit, a start key, a stop key, a reset key and a ten key unit connected to an operation panel CPU;

FIG. 7 is a functional block diagram to explain the maintenance unit according to the first embodiment of the present invention;

FIG. 8 is a conceptual view to illustrate information contents obtained from a memory or an NVRAM or the like by a use information obtaining section and a maintenance information obtaining section;

FIG. 9 is a view to illustrate a correspondence between a variety of maintenance-oriented components contained in the image forming apparatus and information indicative of whether or not the maintenance-oriented components need maintenance, according to the first embodiment of the present invention;

FIG. 10 is a view to illustrate an example of a set value or the like stored in the memory unit;

FIG. 11 is a view to illustrate an example of a screen display in a display unit 804 when a maintenance-oriented component needs maintenance in the image forming apparatus according to the first embodiment of the present invention;

FIG. 12 is a flowchart to explain a flow of processes in the maintenance unit of the image forming apparatus according to the first embodiment of the present invention;

FIG. 13 is a functional block diagram of a maintenance unit of an image forming apparatus according to a second embodiment of the present invention; and

FIG. 14 is a flowchart to illustrate a flow of processes in a maintenance method of the image forming apparatus according to the second embodiment of the present invention.

### DETAILED DESCRIPTION

Hereinafter, embodiments of the present invention will be described with reference to the accompanying drawings.

### First Embodiment

A first embodiment according to the present invention will now be described.

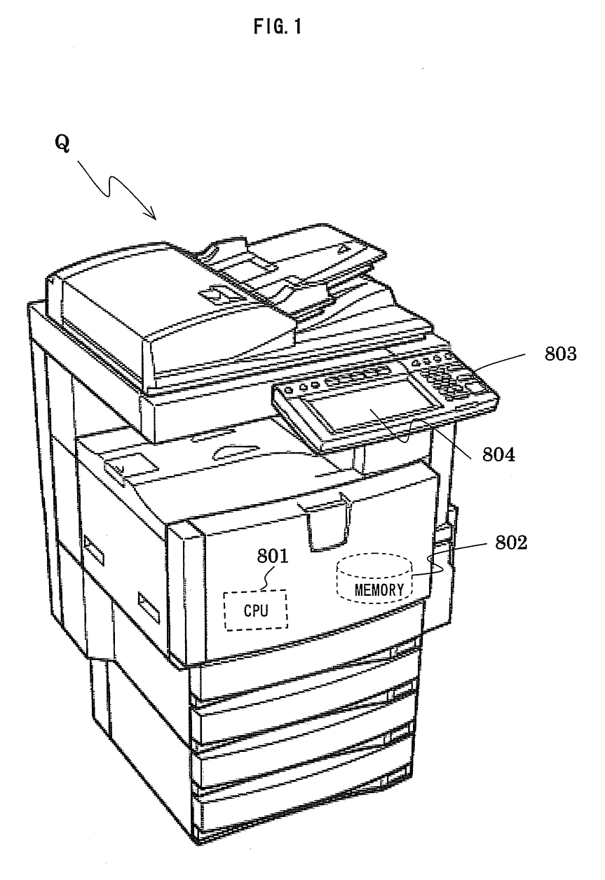

FIG. 1 is an external perspective view of an image forming apparatus having “maintenance unit of image forming apparatus” according to a first embodiment of the present invention.

Here, the image forming apparatus Q according to the present embodiment is assumed to be, for example, an MFP (Multi-Function Peripheral).

The image forming apparatus Q according to the present embodiment has a color copy function, a color scanner function, a color printer function and the like. In addition, the image forming apparatus Q can transmit a scan image to a desired destination by e-mail over network, reserve a scan image in a filing box to give and take image data over network, or realize a function of a network printer or a facsimile.

As shown in FIG. 1, the image forming apparatus Q includes a CPU 801, a memory 802, an operation entry unit 803 and a display unit 804.

The CPU 801 conducts a variety of processes in a maintenance unit of the image forming apparatus and also realizes a variety of functions by executing programs stored in the memory 802. The memory 802 may consist of, for example, a RAM (Random Access Memory), a ROM (Read Only Memory), a DRAM (Dynamic Random Access Memory), an SRAM (Static Random Access Memory), a VRAM (Video RAM), an HDD (Hard Disk Drive) or the like and stores lots of information and programs used by the maintenance unit of the image forming apparatus.

The operation entry unit 803 may consist of, for example, a keyboard, a mouse, a touch panel, a touchpad, a graphics table or the like.

The display unit 804 may consist of, for example, an LCD (Liquid Crystal Display), an EL (Electronic Luminescence), a PDP (Plasma Display Panel), a CRT (Cathode Ray Tube) or the like.

Functions of the operation entry unit 803 and the display unit 804 can be realized by so-called a touch panel display.

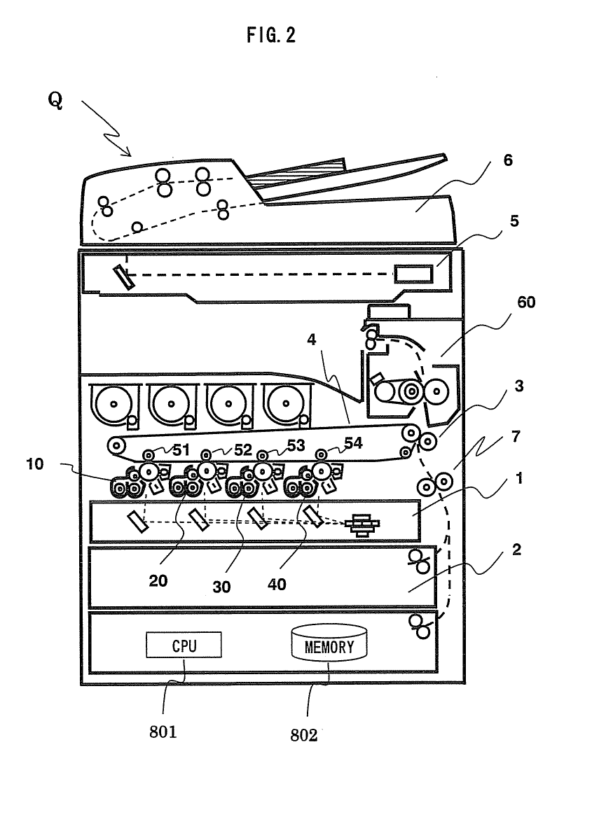

FIG. 2 is a longitudinal cross-sectional view to illustrate the maintenance unit of the image forming apparatus according to the first embodiment of the present invention.

Hereinafter, a fundamental operation (herein, a full color copy operation) of the image forming apparatus Q according to the first embodiment of the present invention will be described.

A copy operation begins by setting original documents on a not-shown document plate or an RADF (Reversible Automatic Document Feeder) 6 disposed above an image read-out unit 5, entering copies, a used paper, a copy mode and the like on the operation entry unit 803 and pressing a start key.

The original documents set on the not-shown document plate or the RADF (Reversible Automatic Document Feeder) 6 are read out by the image read-out unit 5. Image data of an image read out by the image read-out unit 5 are developed into image data of each color of yellow, magenta, cyan and black through a predetermined image process and then are stored in a page memory. In addition, a process unit 10 for forming a yellow image (Y), a process unit 20 for forming a magenta image (M), a process unit 30 for forming a cyan image (C) and a process unit 40 for forming a black image (K) are sequentially disposed in a main body of the apparatus.

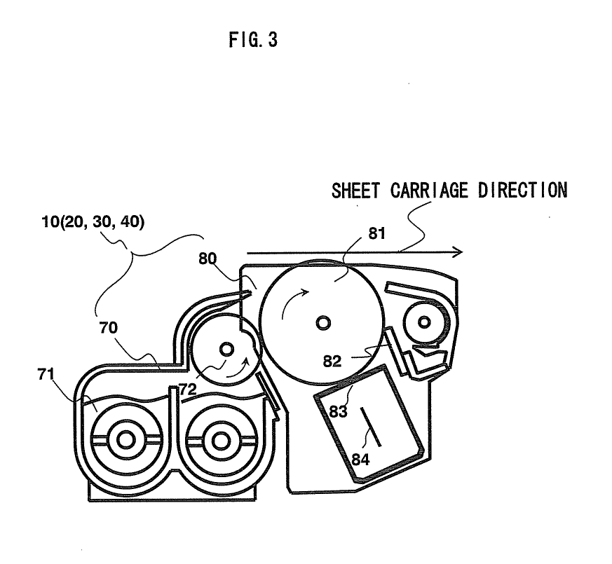

FIG. 3 is a longitudinal cross-sectional view to schematically illustrate a process unit of the image forming apparatus according to the present embodiment. FIG. 3 illustrates the configuration of the process unit 10 for forming a yellow image (Y) as a representative of the process units 10 to 40.

As shown in FIG. 3, the process unit 10 includes a development unit 70 and a drum unit 80. A photoconductive member 81 disposed inside the drum unit 80 rotates in a shown arrow direction and a charge needle 84 connected to a not-shown high voltage source is applied with a high voltage; thereby a corona discharge occurs toward the photoconductive member 81 from the front end of the charge needle 84, resulting in charging a surface of the photoconductive member 81.

The surface of the photoconductive member 81 is charged with almost the same surface potential as a voltage applied to a charge grid 83. A laser exposure unit 1 shown in FIG. 2 exposes the photoconductive member 81 to a laser based on the yellow image data stored in the above-mentioned page memory. The related laser exposure forms an electrostatic latent image on a photoconductive surface of the photoconductive member 81.

The electrostatic latent image formed on the photoconductive member 81 is developed by the development unit 70 (so-called, developing) and thus a visible toner image is formed on the photoconductive member 81 by a toner. Here, the development unit 70 contains a yellow development agent 71 corresponding to the process unit 10(Y) shown in FIG. 2 and a yellow image is formed on the photoconductive member 81.

The other process units 20(M), 30(C) and 40(K) also perform the same process as the process unit 10(Y) to generate toner images of colors corresponding to the process units.

The yellow image formed on the photoconductive member 81 by the process unit 10(Y) disposed as shown in FIG. 2, accompanied by start of the copy operation, is transcribed into a middle transcript belt 4 by a bias voltage applied to a primary transcript roller 51(Y). Subsequently, the magenta image formed on the photoconductive member 81 by the process unit 20(M) is transcribed into the middle transcript belt 4 by a bias voltage applied to a primary transcript roller 52(M). Subsequently, the cyan image formed on the photoconductive member 81 by the process unit 30(C) is transcribed into the middle transcript belt 4 by a bias voltage applied to a primary transcript roller 53(C). In addition, the black image formed on the photoconductive member 81 by the process unit 40(K) is transcribed into the middle transcript belt 4 by a bias voltage applied to a primary transcript roller 54(K). As such, the toner images of yellow, magenta, cyan and black are transcribed and overlapping into the middle transcript belt 4.

When a toner remains on the photoconductive member 81 of each of the process units 10, 20, 30 and 40 after transcribing the toner images into the middle transcript belt 4, a cleaning blade 82 removes the remaining toner from the photoconductive surface of the photoconductive member 81.

A sheet which is a recording medium is picked up from a cassette 2 and carried, upon start of the copy operation, and stopped temporarily by a resist roller 7. As such, the image formed on the middle transcript belt 4 is synchronized with a position of the carried sheet by the resist roller 7. The sheet starts to be carried by the resist roller 7, and the sheet and the toner image transcribed into the middle transcript belt 4 are drawn to a secondary transcript position due to a secondary transcript roller 3. The toner image is transcribed into the sheet drawn to the secondary transcript position from the middle transcript belt 4 by a bias voltage applied to the secondary transcript roller 3.

The toner image transcribed into the sheet from the middle transcript belt 4 is nipped and carried while heated by the fixer 60 and thereby the toner is melted and penetrated into the sheet to be fixed thereto as an everlasting image.

The sheet to which the toner image is heated and fixed by the fixer 60 is carried to a predetermined discharge tray and then discharged out of the apparatus.

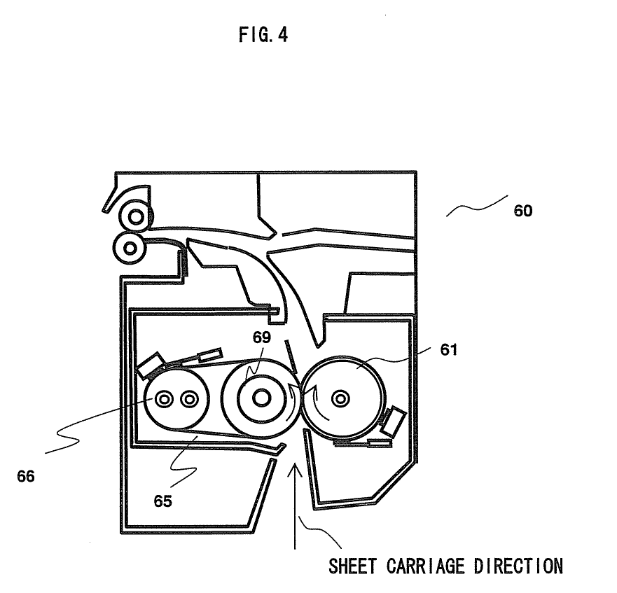

FIG. 4 is a longitudinal cross-sectional view to illustrate a detail of a configuration of the fixer 60 for fixing the toner image, which is transcribed into the sheet from the middle transcript belt 4, to the sheet by heating.

The fixer 60 heats the sheet using a heating belt 65 and a pressing roller 61 and also nips and carries it, to fix the toner image to the sheet.

In detail, the heating belt 65 is rolled and hanged on a fixing roller 69 and the heating roller 66. A belt surface of the heating belt 65 heated by the heating roller 66 and a roller surface of the pressing roller 61 nip and carry the sheet into which the toner image is transcribed, to fix the toner image to the sheet by heating.

Successively, an operation of forming a black-and-white image in the image forming apparatus according to the present embodiment will be described.

When the black-and-white image is formed on a sheet, the middle transcript belt 4 and the primary transcript roller 51(Y), the primary transcript roller 52(M) and the primary transcript roller 53(C) inside of the middle transcript belt 4 are estranged from the photoconductive member of each of the process unit 10(Y), the process unit 20(M) and the process unit 30(C) by a not-shown estranging device. Thereby, the middle transcript belt 4 contacts to only the photoconductive member of the process unit 40(K). In this state, the process unit 10(Y), the process unit 20(M) and the process unit 30(C) are not driven, and only the process unit 40(K) is driven.

The image forming apparatus according to the present embodiment periodically forms a toner image having a predetermined pattern on the middle transcript belt 4 and reads out a reflectivity from the image on the middle transcript belt 4 using a sensor, to automatically conduct an image stability operation, in order to restrict an image variation due to an environment variation such as a temperature or a humidity, etc., or expenditure of expendables.

The image forming apparatus according to the present embodiment periodically forms an image on the middle transcript belt 4 to automatically conduct a correction, in order to restrict a color overlap or a color mismatch due to a variation of exposure width or exposure position of a scanning light on the photoconductive member 81 resulting from distortion of a lens generated by a temperature variation of the laser exposure unit 1, in the same manner as the above-described image quality stability operation.

In the image forming apparatus according to the present embodiment, components (maintenance-oriented components) which need maintenance such as a periodic change and the like include, for example, components of the following (1) to (11):

(1) the respective development agents of yellow, magenta, cyan and black within the development units 70 contained in the process unit 10(Y), the process unit 20(M), the process unit 30(C) and the process unit 40(K); (2) the photoconductive members 81 contained inside the drum units 80 for the respective colors of yellow, magenta, cyan and black; (3) the cleaning blade 82; (4) the charge grid 83; (5) the charge needle 84; (6) the fixing belt 65 disposed inside the fixing unit 60; (7) the pressing roller 61; (8) the fixing roller 69; (9) the middle transcript belt 4; (10) the primary transcript roller 51(Y), the primary transcript roller 52(M), the primary transcript roller 53(C) and the primary transcript roller 54(K); and (11) the secondary transcript roller 3.

In addition, components which need maintenance such as a change, a supplement, a calibration or the like by periodic maintenance are plural, but substantially they are largely classified into development agents of the respective colors of yellow, magenta, cyan and black; drum unit components of the respective colors of yellow, magenta, cyan and black; and other fixing related and transcript related components.

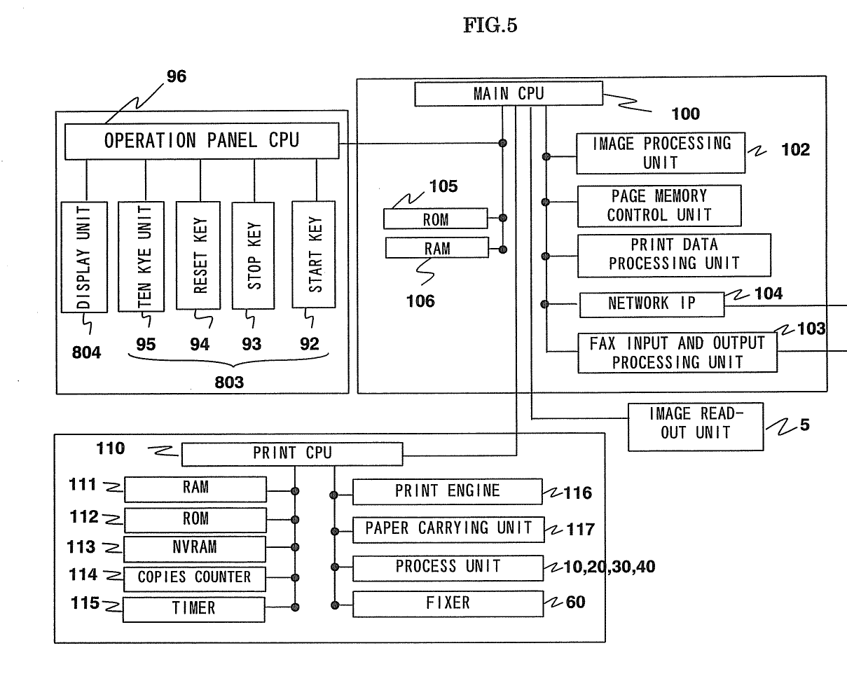

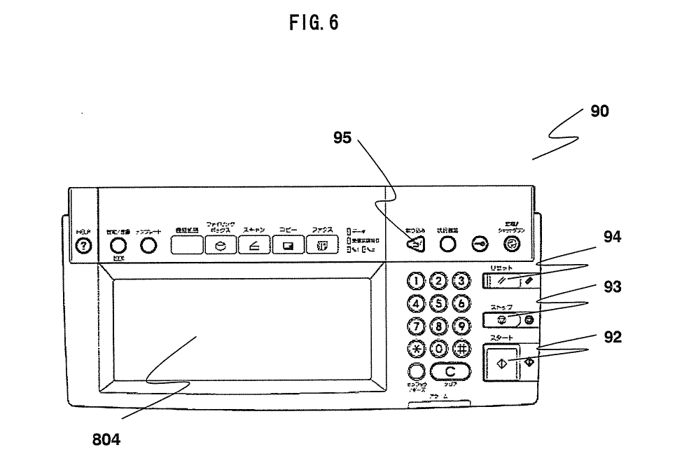

FIG. 5 is a view to illustrate a basic configuration of a control circuit of the maintenance unit of the image forming apparatus according to the present embodiment. In addition, FIG. 6 is a view to illustrate details of a display unit 804, a start key 92, a stop key 93, a reset key 94 and a ten key unit 95 connected to an operation panel CPU 96.

A main CPU 100 controls the operation panel CPU 96, a print CPU 110 and an image read-out unit 5 as one. The print CPU 110 controls a print engine 116, a paper carriage unit 117, a process unit 118 and the fixer 60 and the like.

An operation of the operation panel transmits information to the main CPU 100 from the operation panel CPU 96 and thus the print CPU 110 starts a variety of print operations.

A set value for each of the plural maintenance-oriented components or a current value measured for the plural maintenance-oriented components is counted by a copies counter 114 or by a timer 115. A counted value measured as such is stored in, for example, an NVRAM 113.

The print CPU 110 reads various count results from the NVRAM 113, performs a variety of processes according to the corresponding count results, and displays on the display unit 804 in cooperation with the CPU 801, the main CPU 100 and the operation CPU 96.

Subsequently, a variety of functions of the maintenance unit included in the image forming apparatus Q according to the present embodiment will be described.

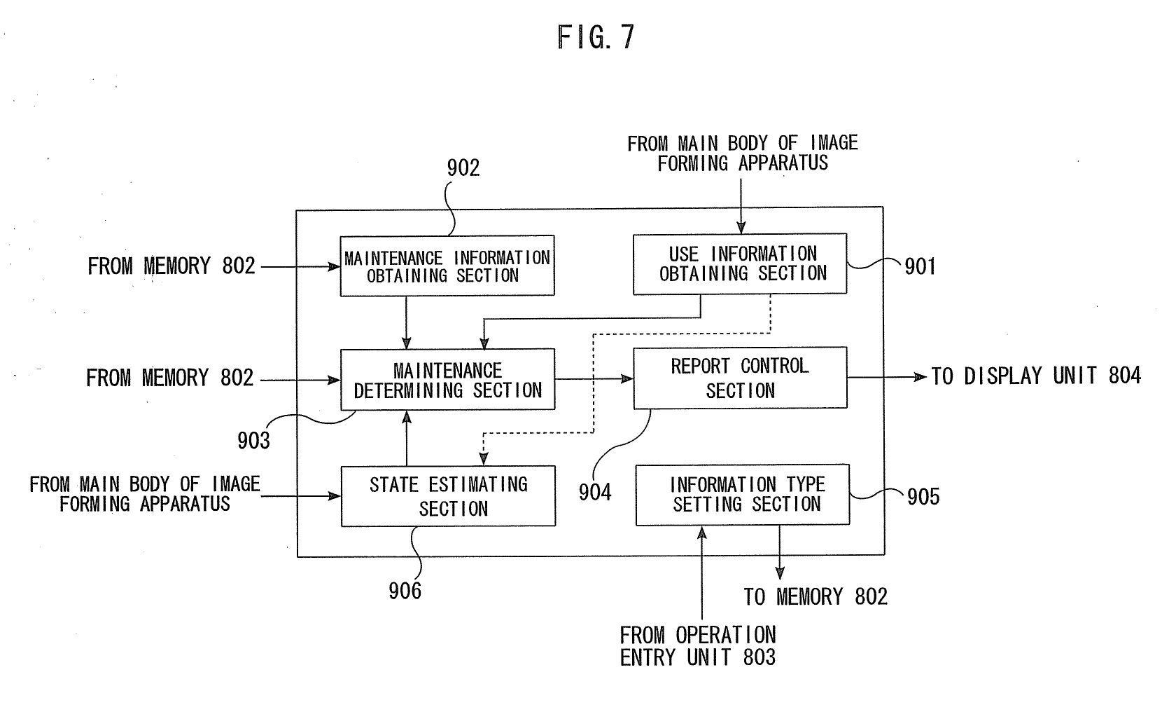

FIG. 7 is a functional block diagram to explain the maintenance unit according to the present embodiment. The maintenance unit according to the present embodiment includes a use information obtaining section 901, a maintenance information obtaining section 902, a maintenance determining section 903, a report control section 904, an information type setting section 905 and a state estimating section 906.

The use information obtaining section 901 obtains information for a use state of each of a plurality of maintenance-oriented components from the CPU 801, the main CPU 100 and the operation CPU 96, etc., or reads it from the memory 802 or the NVRAM 113, etc.

In detail, the use information obtaining section 901 obtains at least any information among a driving frequency, a driving time, a load situation and a use condition of the maintenance-oriented component.

“Use state of the maintenance-oriented component” includes, for example, “black-and-white copies,” “color copies,” “a print ratio (corresponding to a toner consumption amount),” “a remaining amount of a flash toner in a toner supply tank,” “a wasted toner amount recovered in a wasted toner tank,” “the number of rotations of a rotating maintenance-oriented component.”

Here, the “driving frequency” refers to, for example, the number of rotations, the number of reciprocating steps, the number of open and close or the like of a variety of driving components which need maintenance.

The “driving time” refers to, for example, overall driving times of each of a variety of driving components which need maintenance since they are installed in the image forming apparatus.

The “load situation” refers to, for example, a magnitude of a load added to the maintenance-oriented component or the number of repetitions of a repeated load.

The “use condition” refers to a condition when the maintenance-oriented component is used for the image forming apparatus. In detail, there are, for example, conditions, “which is of a color print and a black-and-white print,” “how are temperature and humidity conditions.”

The maintenance information obtaining section 902 obtains maintenance information for “a state of needing maintenance” which is preset for each of the plural maintenance-oriented components.

The maintenance determining section 903 determines whether or not each of the plural maintenance-oriented components lies in a state of needing maintenance, based on information obtained by the use information obtaining section 901 and the maintenance information obtaining section 902.

In this case, the “state of needing maintenance” means, for example, “a state of needing a change or a calibration of components due to the driving components etc., being expended (damage, abrasion or the like) exceeding an allowance limit” with respect to “copies” or “the number of rotations of a rotating maintenance-oriented component.” In addition, for example, the “state of needing maintenance” means “a state of needing a supply due to consumption exceeding an allowance limit” with respect to “the print ratio (corresponding to a toner consumption amount)” or “the remaining amount of a flash toner in a toner supply tank.” Further, for example, the “state of needing maintenance” means “a state of needing extracting a recovered wasted toner out of the apparatus due to a recovery amount exceeding an allowance amount” with respect to “the wasted toner amount recovered in a wasted toner tank.”

The report control section 904 reports in order to take a look at maintenance-oriented components (at least one maintenance-oriented component) which are determined to need maintenance by the maintenance determining section 903.

Here, the “report in order to take a look at” is not limited to a list display on the screen of the display unit 804 installed in the image forming apparatus Q, but includes a facsimile transmission via a facsimile input and output unit 103 or an e-mail transmission via a network IF 104 in a readable state with a look format, for example. In this case, a destination to which the facsimile or the e-mail is transmitted may include, for example, a service station or a communication terminal belonging to a service man.

The information type setting section 905 separately sets a type of information obtained for each of a plurality of maintenance-oriented components by the use information obtaining section 901, based on a user's entry.

The use information obtaining section 901 obtains information of a type set by the information type setting section 905, for each of the plural maintenance-oriented components.

Thereby, for example, according to a user's intention, a type of information obtained for at least one of the maintenance-oriented components may be different from types of information obtained for the other maintenance-oriented components from the plural maintenance-oriented components. Of course, it is possible to set as default such that types of information obtained by the information obtaining section are different, if necessary. Here, “different types” mean that kinds of information are different, for example, various pieces of information, “the black-and-white copies,” “the color copies,” “the print ratio (corresponding to a toner consumption amount),” “the remaining amount of a flash toner in a toner supply tank,” “the wasted toner amount recovered in the a wasted toner tank,” and “the number of rotations of a rotating maintenance-oriented component” are different in types.

The state estimating section 906 estimates a future use state of a maintenance-oriented component corresponding to information, based on the use information obtained by the use state obtaining section 901 in the past. In detail, an estimation algorithm in the state estimating section 906 includes, for example, a method of estimating an increase of a future use amount of a maintenance-oriented component based on an increase (slope) of a past use amount (copies or a driving time) of the maintenance-oriented component. Of course, it is obvious that an algorithm for estimating the use amount of a maintenance-oriented component may include well-known methods as well as the above-described method.

The report control section 904 reports in order to take a look at a maintenance-oriented component of which a use state estimated within a predetermined time period by the state estimating section 906 is determined to lie in a state of needing maintenance by the maintenance determining section 903.

The report control section 904 reports in order to take a look at “a second maintenance-oriented component” with “a first maintenance-oriented component”, a use state of the “second maintenance-oriented component” estimated within a predetermined time period by the state estimating section 906 being determined to lie in a state of needing maintenance by the maintenance determining section 903 when the maintenance determining section 903 determines that there is the “first maintenance-oriented component” needing maintenance.

Report is made in order to take a look at both components which are determined to need maintenance at a timing when it is determined that there are components needing maintenance and components which are determined to need maintenance in the near future; thereby it is possible for a service man to summarize and conduct maintenance works needed within a short period of time.

The report control section 904 reports in order to take a look at “a first maintenance-oriented component” and “a second maintenance-oriented component,” if “the second maintenance-oriented component” is determined to need maintenance by the maintenance determining section 903 and when the maintenance determining section 903 determines that there is “the first maintenance-oriented component” needing maintenance and determines that there is “the second maintenance-oriented component” of which a use state estimated within a predetermined time period by the state estimating section 906 lies in a state of needing maintenance.

According to such configuration, when it is determined that there are components needing maintenance and it seems that components needing maintenance occur in the near future, a maintenance for components which are currently determined to need maintenance is postponed and then it is possible to report ‘need of maintenance’ in total when it is determined that components which are estimated to need maintenance in the near future actually need maintenance. This can contribute to increase of a work efficiency of a service man.

In addition, at least one of a plurality of maintenance-oriented components may be set different from the other maintenance-oriented components in levels of parameters indicative of maintenance information for states of needing maintenance.

Here, the “levels of parameters indicative of maintenance information” means, for example, a component lifetime preset for a maintenance-oriented component, and so forth. In detail, for example, there are “a driving time (time) needing a component change,” “a driving frequency (frequency) needing a component change,” “copies (number) needing a component change,” “the number of temperature variations (number) needing a component change,” “a load weight (kg) needing a component change” and the like.

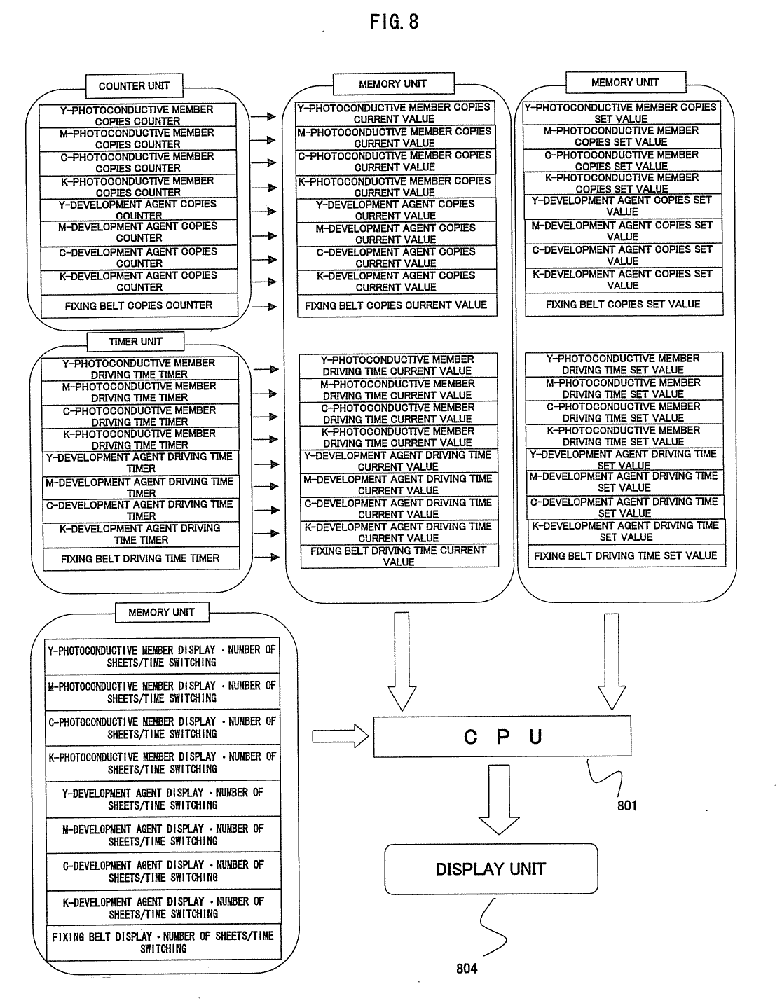

A process of the maintenance unit according to the present embodiment will now be described in detail. FIG. 8 is a conceptual view to illustrate information contents obtained from the memory 802 or the NVRAM 113 by the use information obtaining section 901 and the maintenance information obtaining section 902.

Herein, the yellow photoconductive member 81 as a representative of expendable components mounted in the yellow photoconductive unit 80 will be described. Likewise, each of magenta, cyan and black photoconductive members 81 as a representative of each of magenta, cyan and black photoconductive units 80 will be described.

FIG. 8 shows a Y-photoconductive member copies counter, an M-photoconductive member copies counter, a C-photoconductive member copies counter and a K-photoconductive member copies counter, as a function of the copies counter 114 for counting copies of the respective photoconductive members. Further, FIG. 8 shows a Y-photoconductive member driving time timer, an M-photoconductive member driving time timer, a C-photoconductive member driving time timer and a K-photoconductive member driving time timer, as the timer 115 for counting driving times of the respective photoconductive members.

FIG. 8 shows a Y-development agent copies counter, an M-development agent copies counter, a C-development agent copies counter and a K-development agent copies counter, as a function of the copies counter 114 for counting copies of the respective development unit 70 of yellow, cyan, magenta and black.

Further, FIG. 8 shows a Y-development agent driving time timer, an M-development agent driving time timer, a C-development agent driving time timer and a K-development agent driving time timer, as the timer 115 for counting driving times of the respective development unit 70.

In addition, a fixing belt copies counter is shown, as a function of the copies counter 114 for counting the copies of the fixing belt 65 which is a representative of the expendable components for the fixing belt 65.

A fixing belt driving time timer for counting a driving time of the fixing belt 65 is shown, as a function of the timer 115 for counting a driving time of the fixing belt.

The respective current values of copies counted by the counters and driving times counted by the timers are stored in the memory unit (for example, NVRAM 113).

The memory unit (for example, NVRAM 113) also stores (1) copies set values to define copies as a reference of a change time and (2) driving time set values to define a driving time as a reference of a driving time (see FIG. 8 for details) which are set for the above-mentioned respective maintenance-oriented components.

These set values are values corresponding to recommended change times of the respective components and are stored as initial values upon shipment from a factory. The values corresponding to the recommended change times upon shipment from a factory are values derived from a deterioration degree of components based on a predetermined use condition. Thus, depending on an actual use state (for example, copies a day, continuous copies at one time job, black-and-white and color ratio and the like), expended states of the respective components are different from each other, and thus the initial set value upon shipment from a factory of each of the components may exceed the lifetime or may reach the lifetime although it can be still used. For this reason, a service man can operate the operation entry unit to set arbitrary values as maintenance information for each of the maintenance-oriented components.

When entering “0” as a set value of maintenance information, a component which is given “0” is set such that a periodic change message is not sent. The set values set as such may be stored, for example, in the memory 802.

Herein, at least any one of “copies,” “a driving time” and “the earlier one of the copies and the driving time” is set in the above-described memory unit (NVRAM 113), as a reference to determine maintenance timing for components needing maintenance.

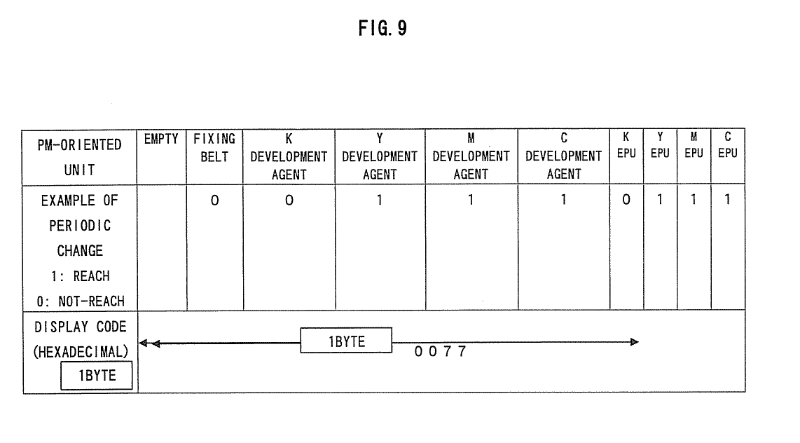

Hereinafter, a display method as to whether or not a maintenance work needs to be conducted will be described in a message displayed on the display unit 804. FIG. 9 is a view to illustrate a correspondence between a variety of maintenance-oriented components contained in the image forming apparatus Q and information indicative of whether or not the maintenance-oriented components need maintenance, according to the present embodiment.

As shown in FIG. 9, the report control section 904 displays a message of needing a maintenance work on the display unit 804 when “0” is set in a storage region of the memory unit corresponding to each component and “copies” exceed a set value determined in advance.

Meanwhile, the report control section 904 displays a message of needing maintenance work on the display unit 804 when “1” is set in a storage region of the memory unit corresponding to each component and “a driving time” exceeds a set value determined in advance.

In addition, the report control section 904 displays a message of needing a maintenance work on the display unit 804 when “2” is set in a storage region of the memory unit corresponding to each component and any one of “copies” and “a driving time” exceeds a set value determined in advance.

The set values may be set, for example, upon shipment from a factory. Of course, it is obvious that a service man can operate the operation entry unit 803 to change the setting even in an installed state in a place used by a user.

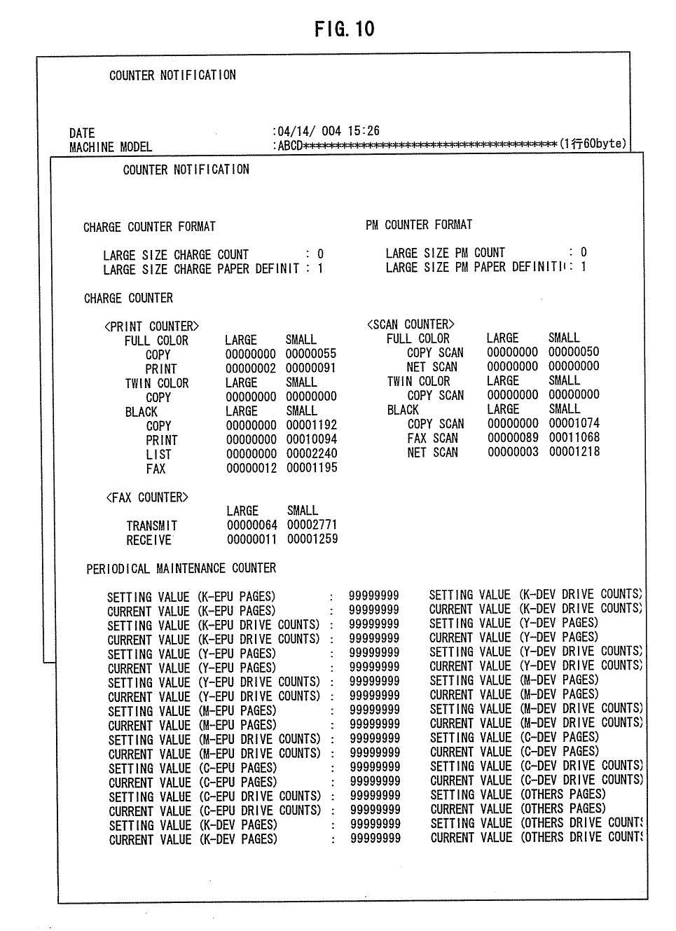

The memory unit (NVRAM 113) stores, for example, (1) a set value to define a method for determining a timing to conduct maintenance, (2) current copies and a driving time of the respective maintenance-oriented components and (3) set values of copies and a driving time to define a timing to conduct maintenance for the respective maintenance-oriented components, with respect to the respective photoconductive members of yellow, magenta, cyan and black, the respective development agents of yellow, magenta, cyan and black, and the fixing belt. FIG. 10 is a view to illustrate an example of a set value or the like stored in the memory unit.

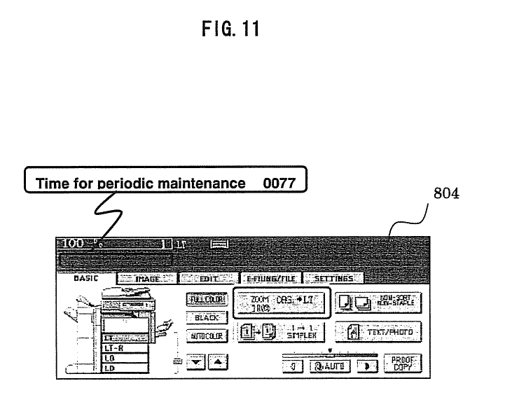

FIG. 11 is a view to illustrate an example of a screen display in the display unit 804 when a maintenance-oriented component needs maintenance in the image forming apparatus according to the present embodiment.

In detail, the report control section 904 displays a message of needing maintenance as well as a hexadecimal sign such as “0077” for specifying a maintenance-oriented component which is determined to need maintenance by the maintenance determining section 903, such as, for example, “Time for Periodic maintenance 0077,” which can be taken a look at.

Here, a code taken a look at with a hexadecimal sign by the report control section 904, as disclosed in FIG. 9, is a hexadecimal code formed by giving “1” when each component which is assigned 1-bit reaches a periodic change time.

The hexadecimal code can be taken a look at on the display unit 804 and thus it can be seen at a glance which components reach a periodic change time.

As shown in the same figure, states of a plurality of maintenance-oriented components can be displayed on a screen in order to be taken a look at in a small display space, by representation of the hexadecimal sign as to whether or not the maintenance-oriented components lie in a state of needing maintenance.

Although the message shown in FIG. 11 is displayed on the screen, a print operation can be continuously kept going, and a content of the code in the message is updated and displayed in a revised state when another maintenance-oriented component reaches a periodic change time in a process of displaying the message on the display unit 804 and keeping the print operation.

A message reported by the report control section 904 includes information for, as shown in FIG. 10, for example, “current copies,” “a current driving time,” “a set value by the number of sheets for defining a preset maintenance timing” and “a set value by a driving time for defining a preset maintenance timing” regarding each maintenance-oriented component, as a periodic maintenance counter.

When a service man or a user which is reported by the report control section 904 completes maintenance for a maintenance-oriented component needing maintenance, the CPU 801 resets the current value of copies or a driving time for the maintenance-oriented component for which maintenance is completed.

The setting by the CPU 801 as to whether or not to complete maintenance may be automatically executed by sensing a remaining amount of a toner in the toner tank or may be executed by an operation entry of a service man into the operation entry unit 903. At this time, a date for changing the maintenance-oriented component of which the current value is reset is stored in, for example, the memory unit (NVRAM 113).

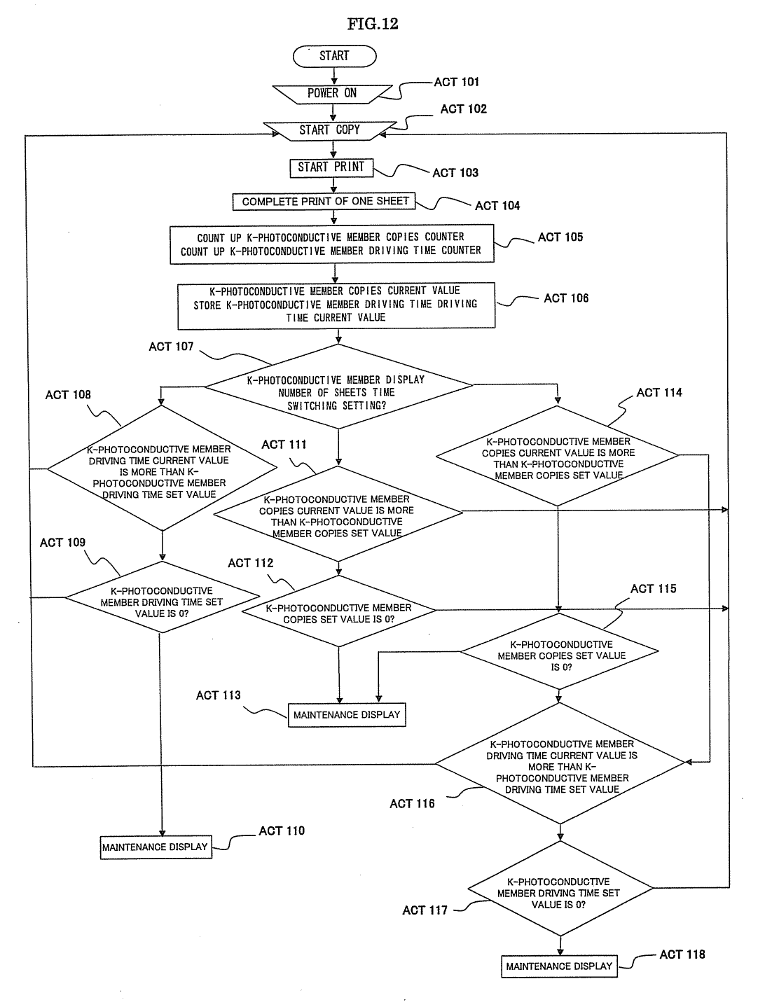

FIG. 12 is a flowchart to explain a flow of processes in the maintenance unit of the image forming apparatus according to the first embodiment of the present invention. Herein, a flow of a maintenance work for the black photoconductive member is shown as an example.

When the image forming apparatus Q is powered on (ACT 101), the copy start button on the operation entry unit 803 is pressed (ACT 102) and a copying starts (ACT 103), the CPU 801 counts up the counter value to represent copies and a driving time regarding each maintenance-oriented component stored in the memory unit (ACT 105) whenever a print completes each sheet (ACT 104).

The counted-up copies and driving time is stored in the memory unit (NVRAM 113), for example (ACT 106).

Subsequently, the CPU 801 determines that any one of a driving time (1) of the black photoconductive member, copies (0) of the black photoconductive member and a driving time and copies (2) of the black photoconductive member is selected, as a reference of determination for maintenance (ACT 107). Such set information is set by a service man or the like in advance and is stored in the memory unit, for example, the NVRAM 113.

First, a case of the driving time (1) of the black photoconductive member being selected as a reference of determination for maintenance (ACT 107, 1) will be described.

When a driving time (accumulated driving time since reset in the previous time until the present time) of the black photoconductive member is more than a set value (ACT 108, Yes) and “0 (report of needing maintenance is not made)” is not set as a set value for a driving time of the black photoconductive member (ACT 109, No), the report control section 904 reports of needing maintenance for the black photoconductive member (ACT 110).

Subsequently, a case of the copies (0) of the black photoconductive member being selected as a reference of determination for maintenance (ACT 107, 0) will be described.

When copies (accumulated copies since reset in the previous time until the present time) of the black photoconductive member is more than a set value (ACT 111, Yes) and “0 (report of needing maintenance is not made)” is not set as a set value for copies of the black photoconductive member (ACT 112, No), the report control section 904 reports of needing maintenance for the black photoconductive member (ACT 113).

Then, a case of the driving time and the copies (2) of the black photoconductive member being selected as a reference of determination for maintenance (ACT 107, 2) will be described.

When copies (accumulated copies since reset in the previous time until the present time) of the black photoconductive member is more than a set value (ACT 114, Yes) and “0 (report of needing maintenance is not made)” is not set as a set value for copies of the black photoconductive member (ACT 115, No), the report control section 904 reports of needing maintenance for the black photoconductive member (ACT 113).

Meanwhile, when “0 (report of needing maintenance is not made)” is set as a set value for copies of the black photoconductive member (ACT 115, Yes), a driving time (accumulated driving time since reset in the previous time until the present time) of the black photoconductive member is more than a set value (ACT 116, Yes) and “0 (report of needing maintenance is not made)” is not set as a set value for a driving time of the black photoconductive member (ACT 117, No), the report control section 904 reports of needing maintenance for the black photoconductive member (ACT 118).

Each operation at the processes by the maintenance unit of the image forming apparatus described above can be realized, for example, by the CPU 801 executing a maintenance program of an image forming apparatus stored in the memory 802.

The program for executing each operation described above in a computer comprising the maintenance unit of the image forming apparatus can be provided as a maintenance program of an image forming apparatus. Although the present embodiment exemplifies that the corresponding program for realizing a function to embody the invention is pre-recorded in a storage region provided inside the apparatus, but the invention is not limited thereto, the same program may be downloaded to the apparatus over a network or the same program stored in a computer readable recording medium may be installed in the apparatus. A recording medium may be of any types if only it can store a program and is computer readable. In detail, the recording medium includes, for example, an internal storage device embedded in a computer such as a ROM, a RAM or the like, portable recording media such as a CD-ROM, a flexible disc, a DVD disc, a magneto-optical disc or an IC card, a database to preserve computer programs, or a transmission medium on other computers and a database thereof or a line, or the like. In addition, a function obtained by installment or download in advance may be realized in cooperation with an OS (operating system) of the apparatus. The program according to the present embodiment is assumed to contain a program which dynamically generates an executable module.

### Second Embodiment

The second embodiment of the present invention will now be described.

The second embodiment of the present invention is different from the first embodiment in a determination reference for report. Hereinafter, elements of the present embodiment having the same functions as the first embodiment are given the same reference numerals, the description of which will be omitted.

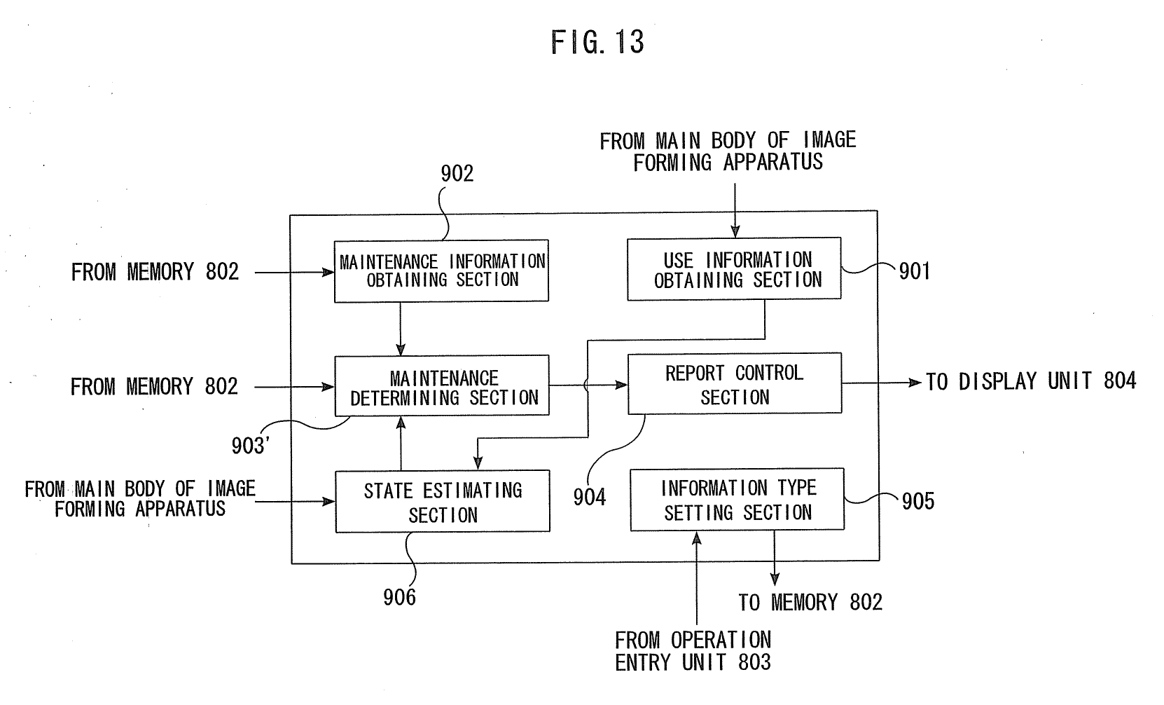

FIG. 13 is a functional block diagram of a maintenance unit of an image forming apparatus according to the second embodiment of the present invention.

The maintenance unit of the image forming apparatus according to the second embodiment of the present invention includes a use information obtaining section 901, a maintenance information obtaining section 902, a maintenance determining section 903′, a report control section 904, an information type setting section 905 and a state estimating section 906.

Various functions of the maintenance unit according to the present embodiment will be described in detail.

The use information obtaining section 901 obtains information for a use state of each of a plurality of maintenance-oriented components.

The maintenance information obtaining section 902 obtains maintenance information for a state of needing maintenance which is preset for each of the plural maintenance-oriented components.

The state estimating section 906 estimates a future use state of a maintenance-oriented component corresponding to information, based on the information for a use state obtained in the past by the use information obtaining section 901.

The maintenance determining section 903′ determines whether a use state estimated within a predetermined time period lies in a state of needing maintenance for each of the plural maintenance-oriented components, based on a use state estimated by the state estimating section 906 and information obtained by the maintenance information obtaining section 902.

The report control section 904 reports in order to take a look at a maintenance-oriented component which is determined to need maintenance by the maintenance determining section 903′.

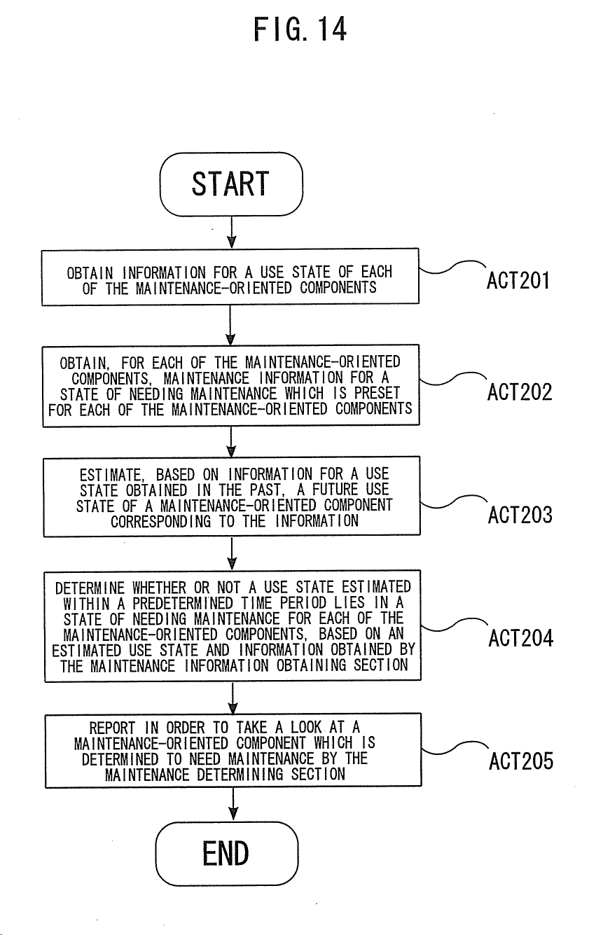

FIG. 14 is a flowchart to illustrate a flow of processes in a maintenance method of the image forming apparatus according to the second embodiment of the present invention.

The use information obtaining section 901 obtains information for a use state of each of the plural maintenance-oriented components (ACT 201).

The maintenance information obtaining section 902 obtains maintenance information for a state of needing maintenance which is preset for each of the plural maintenance-oriented components (ACT 202).

The state estimating section 906 estimates a future use state of a maintenance-oriented component corresponding to information, based on the information for a use state obtained in the past by the use information obtaining section 901 (ACT 203).

The maintenance determining section 903′ determines whether or not a use state estimated within a predetermined time period lies in a state of needing maintenance for each of the plural maintenance-oriented components, based on a use state estimated by the state estimating section 906 and information obtained by the maintenance information obtaining section 902 (ACT 204).

The report control section 904 reports in order to take a look at a maintenance-oriented component which is determined to need maintenance by the maintenance determining section 903′ (ACT 205).

Although the embodiment shown in FIG. 14 exemplifies that the obtaining the maintenance information (ACT 202) is performed prior to the estimating the future use state of a maintenance-oriented component (ACT 203), determination by the maintenance determining section 903′ has only to obtain the processing results at ACT 202 and ACT 203. That is, the estimating the future use state of a maintenance-oriented component (ACT 203) may be performed prior to the obtaining the maintenance information (ACT 202), or both of them may be performed at the same time.

In addition, although the above-described embodiments exemplify that, for explanation's convenience, the respective functions for comprising the maintenance unit of the image forming apparatus may be realized by the CPU 801 executing programs stored in the memory 802, they are not necessarily limited thereto. For example, it is obvious that the above-described respective functions can be realized by the main CPU 100, the operation panel CPU 96 and the print CPU 110 executing the programs stored in the above-described ROM 105 or the RAM 106.

Although the above-described embodiments exemplify that the maintenance unit for maintaining the maintenance-oriented components contained in the image forming apparatus is disposed inside the image forming apparatus, they are not necessarily limited thereto. For example, an external device such as a PC (Personal Computer) or the like which can obtain information for the respective maintenance-oriented components contained in the image forming apparatus can realize the functions of the maintenance unit as described in the above embodiment.

In addition, although the above-described embodiments exemplify that a state the any one of a plurality of maintenance-oriented components contained in the image forming apparatus needs maintenance is displayed on the screen of the display unit 804 of the image forming apparatus and, thereby, a user or a service man is reported, they are not necessarily limited thereto. That is, the presence of a maintenance-oriented component needing maintenance has only to be reported to a user or a service man, for example, the report can be made by transmission of a message using an e-mail or a facsimile.

A plurality of maintenance-oriented components contained in the image forming apparatus are grouped on the unit-basis such as the fixer, the process units or the like in the above-described embodiments, and the maintenance-oriented components comprising the same group are set to have the same components' lifetime as designed. In other words, when a service man actually conducts a maintenance work, components' lifetimes become uniform due to position calibration, installment, separation or the like as one unit. Thereby, for example, when the heating roller comprising the fixer reaches its lifetime, the pressing roller also reaches its lifetime at almost the same timing, and thus it has an effect of lowering a frequency of a service man's visit for the maintenance. Therefore, for example, upon determining a maintenance timing for the process unit, if a maintenance timing for a single component such as the photoconductive member is simply considered, a maintenance for the other maintenance-oriented components comprising the process unit can be conducted at a proper timing.

According to the maintenance unit of each of the above-described embodiments, expended states of the maintenance-oriented components can be grasped suitably for a current situation by additionally considering a determination based on which one of the copies and the driving time reaches a set value earlier, as well as the copies or the driving timing, as a reference of determining whether or not a maintenance-oriented component needs maintenance.

According to the above-described configuration, although times for periodic maintenance of the maintenance-oriented components, caused by a user's use state of the image forming apparatus, are different, it is possible to display proper maintenance information. In addition, a service station or a service man can be reported properly, to lower the number of a service man's visits or to increase work efficiency in a periodic maintenance.

Various modifications and alterations of this invention will be apparent to those skilled in the art without departing from the scope and spirit of this invention, and it should be understood that this is not limited to the illustrative embodiments set forth herein.

As described above in detail, according to the present invention, it is possible to provide a technique capable of grasping the necessity of the maintenance for a plurality of maintenance-oriented components in managing a maintenance work in an image forming apparatus containing the plurality of maintenance-oriented components.

What is claimed is:

1. A maintenance unit of an image forming apparatus comprising:
a use information obtaining section configured to obtain information for a use state of each of a plurality of maintenance-oriented components;
a maintenance information obtaining section configured to obtain maintenance information for a state of needing maintenance, the state being preset for each of the plurality of maintenance-oriented components;
a maintenance determining section configured to determine whether or not the plurality of maintenance-oriented components lie in a state of needing maintenance, based on the information obtained by the use information obtaining section and the maintenance information obtaining section; and
a report control section configured to report in order to take a look at a maintenance-oriented component which is determined to need maintenance by the maintenance determining section.

2. The unit according to claim 1, wherein the use information obtaining section is configured to obtain at least one of a driving frequency, a driving time, a load situation and a use condition of the maintenance-oriented component.

3. The unit according to claim 1, wherein at least one of the plurality of maintenance-oriented components is set different from the other maintenance-oriented components in a level of a parameter indicative of maintenance information for a state of needing maintenance.

4. The unit according to claim 1, further comprising an information type setting section configured to separately set a type of information obtained for each of the plurality of maintenance-oriented components by the use information obtaining section, based on a user's operation entry,
wherein the use information obtaining section is further configured to obtain a type of information set for each of the plurality of maintenance-oriented components by the information type setting section.

5. The unit according to claim 1, wherein the plurality of maintenance-oriented components include at least two maintenance-oriented components which are grouped,
wherein maintenance information set corresponding to each of the grouped maintenance-oriented components is set identical to each other in the same group.

6. The unit according to claim 1, wherein the report control section is further configured to report in order to take a look at a maintenance-oriented component with a hexadecimal sign, the maintenance-oriented component being determined to need maintenance by the maintenance determining section.

7. The unit according to claim 1, further comprising a state estimating section configured to estimate, based on information for a use state obtained in the past by the use information obtaining section, a future use state of a maintenance-oriented component corresponding to the information,
wherein the report control section is further configured to report in order to take a look at a maintenance-oriented component of which a use state estimated within a predetermined time period by the state estimating section is determined to lie in a state of needing maintenance by the maintenance determining section.

8. The unit according to claim 1, wherein the report control section is further configured to report in order to take a look at a second maintenance-oriented component with a first maintenance-oriented component, a use state of the second maintenance-oriented component estimated within a predetermined time period by the state estimating section being determined to lie in a state of needing maintenance by the maintenance determining section when the maintenance determining section determines that there is the first maintenance-oriented component needing maintenance.

9. The unit according to claim 1, wherein the report control section is further configured to report in order to take a look at a first maintenance-oriented component and a second maintenance-oriented component, if the second maintenance-oriented component is determined to need maintenance by the maintenance determining section and when the maintenance determining section determines that there is the first maintenance-oriented component needing maintenance and determines that there is the second maintenance-oriented component of which a use state estimated within a predetermined time period by the state estimating section lies in a state of needing maintenance.

10. A maintenance unit of an image forming apparatus comprising:
a use information obtaining section configured to obtain information for a use state of each of a plurality of maintenance-oriented components;
a maintenance information obtaining section configured to obtain maintenance information for a state of needing maintenance, the state being preset for each of the plurality of maintenance-oriented components;
a state estimating section configured to estimate a future use state of a maintenance-oriented component corresponding to the information, based on the information for a use state obtained in the past by the use information obtaining section;
a maintenance determining section configured to determine whether or not a use state estimated within a predetermined time period lies in a state of needing maintenance for each of the plurality of maintenance-oriented components, based on a use state estimated by the state estimating section and information obtained by the maintenance information obtaining section; and
a report control section configured to report in order to take a look at a maintenance-oriented component which is determined to need maintenance by the maintenance determining section.

11. The unit according to claim 10, wherein the use information obtaining section is configured to obtain at least one of a driving frequency, a driving time, a load situation and a use condition of the maintenance-oriented component.

12. The unit according to claim 10, wherein at least one of the plurality of maintenance-oriented components is set different from the other maintenance-oriented components in a level of a parameter indicative of maintenance information for a state of needing maintenance.

13. The unit according to claim 10, further comprising an information type setting section configured to separately set a type of information obtained for each of the plurality of maintenance-oriented components by the use information obtaining section, based on a user's operation entry,
wherein the use information obtaining section is further configured to obtain a type of information set for each of the plurality of maintenance-oriented components by the information type setting section.

14. The unit according to claim 10, wherein the plurality of maintenance-oriented components include at least two maintenance-oriented components which are grouped,
wherein maintenance information set corresponding to each of the grouped maintenance-oriented components is set identical to each other in the same group.

15. The unit according to claim 10, wherein the report control section is further configured to report in order to take a look at a maintenance-oriented component with a hexadecimal sign, the maintenance-oriented component being determined to need maintenance by the maintenance determining section.

16. The unit according to claim 10, further comprising a state estimating section configured to estimate, based on the information for a use state obtained in the past by the use information obtaining section, a future use state of a maintenance-oriented component corresponding to the information,
wherein the report control section is further configured to report in order to take a look at a maintenance-oriented component of which a use state estimated within a predetermined time period by the state estimating section is determined to lie in a state of needing maintenance by the maintenance determining section.

17. The unit according to claim 10, wherein the report control section is further configured to report in order to take a look at a second maintenance-oriented component with a first maintenance-oriented component, a use state of the second maintenance-oriented component estimated within a predetermined time period by the state estimating section being determined to lie in a state of needing maintenance by the maintenance determining section when the maintenance determining section determines that there is the first maintenance-oriented component needing maintenance.

18. The unit according to claim 10, wherein the report control section is further configured to report in order to take a look at a first maintenance-oriented component and a second maintenance-oriented component, if the second maintenance-oriented component is determined to need maintenance by the maintenance determining section and when the maintenance determining section determines that there is the first maintenance-oriented component needing maintenance and determines that there is the second maintenance-oriented component of which a use state estimated within a predetermined time period by the state estimating section lies in a state of needing maintenance.

19. A maintenance method of an image forming apparatus comprising:
obtaining information for a use state of each of a plurality of maintenance-oriented components;
obtaining maintenance information for a state of needing maintenance, the state being preset for each of the plurality of maintenance-oriented components;
determining whether or not the plurality of maintenance-oriented components lie in a state of needing maintenance, based on the obtained use state information and the obtained maintenance information; and
reporting in order to take a look at a maintenance-oriented component which is determined to need maintenance.

20. The method according to claim 19, further comprising:
estimating, based on information for a use state obtained in the past, a future use state of a maintenance-oriented component corresponding to the information; and
reporting in order to take a look at a maintenance-oriented component of which a use state estimated within a predetermined time period is determined to lie in a state of needing maintenance.
